(19) United States
(12) Patent Application Publication
(10) Pub. No.: US 2021/0035346 A1
(43) Pub. Date: Feb. 4, 2021

(54) Multi-Plane Model Animation Interaction Method, Apparatus And Device For Augmented Reality, And Storage Medium

(71) Applicant: Beijing Microlive Vision Technology Co., Ltd, Beijing (CN)

(72) Inventors: Yi CHEN, Beijing (CN); Ang LIU, Beijing (CN)

(21) Appl. No.: 16/967,950

(22) PCT Filed: Jan. 25, 2019
(86) PCT No.: PCT/CN2019/073078

§ 371 Date: Aug. 6, 2020

(30) Foreign Application Priority Data
Aug. 9, 2018 (CN) 201810900487.7

(51) Int. Cl. G06T 13/20; G06T 19/00; G06T 7/70; G06K 9/00

(52) U.S. Cl. CPC G06T 13/20; G06T 19/006; G06T 2207/10016; G06K 9/00718; G06T 2207/30244; G06T 7/70

(57) ABSTRACT

A multi-plane model animation interaction method, apparatus, and device for augmented reality, and a storage medium are provided. The method includes: acquiring a video image of a real environment; recognizing multiple real planes in the real environment by computing the video image; arranging a virtual object corresponding to the model on one of the multiple real planes; and generating, based on the multiple recognized real planes, an animation track of the virtual object among the multiple real planes. In this method, the animation track of the virtual object is generated based on the real planes recognized from the real environment, such that animation effects of the virtual object can be associated with the real environment, thereby enhancing real sensory experience of users.

### CROSS-REFERENCE TO RELATED APPLICATIONS

The present application claims priority to Chinese Patent Application No. 201810900487.7, titled “MULTI-PLANE MODEL ANIMATION INTERACTION METHOD, APPARATUS AND DEVICE FOR AUGMENTED REALITY, AND STORAGE MEDIUM”, filed on Aug. 9, 2018 with the Chinese Patent Office, which is incorporated herein by reference in its entirety.

### FIELD

The present disclosure relates to the technical field of augmented reality, and in particular to a multi-plane model animation interaction method, a multi-plane model animation interaction method apparatus, and a multi-plane model animation interaction method device for augmented reality, and a storage medium.

### BACKGROUND

Augmented reality (referred to as AR hereinafter), which is also referred to as mixed reality, is a new technology developed based on the computer virtual reality technology. In the augmented reality technology, information of the real world is extracted by using computer technologies, and the information of the real world is superposed with virtual information, to achieve a real experience that the virtual information and the information of the real world concurrently exist in one image or space. The AR technology is widely used in the fields of In the fields of military, scientific research, industry, medical care, games, education, municipal planning, and the like. For example, in the field of medical care, a doctor can accurately position a surgical site with the AR technology.

Fusing of a real image with a virtual animation by using the conventional augmented-reality AR system includes the following processes. A video frame of a real environment is acquired first, and then is computed to acquire a relative orientation of the real environment and a camera. An image frame of a virtual object is generated, and is synthesized with the video frame of the real environment, to obtain a synthesized video frame of the augmented real environment, which is inputted into a video memory and is displayed.

In a augmented reality system performing the above process, after an animation model is arranged in the real environment, a virtual object drawn for the animation model moves among fixed positions, to generate animation effects. However, this animation model has no relationship with planes in the real environment, failing to achieve an effect that the virtual object is associated with the real environment and resulting in poor real sensory experience of users.

### SUMMARY

In view of the above problems, a multi-plane model animation interaction method, a multi-plane model animation interaction apparatus, and a multi-plane model animation interaction device for augmented reality, and a storage medium are provided according to the present disclosure. An animation track of a virtual object drawn for the animation model is determined based on planes that are recognized in a real environment, such that a virtual object animation can be associated with the real environment, thereby enhancing real sensory experience brought by the system.

In order to achieve the above objects, the following technical solutions are provided according to an aspect of the present disclosure.

A multi-plane model animation interaction method for augmented reality is provided. The method includes:

acquiring a video image of a real environment; recognizing multiple real planes in the real environment by computing the video image; arranging a virtual object corresponding to the model on one of the multiple real planes; and generating, based on the multiple recognized real planes, an animation track of the virtual object among the multiple real planes.

Further, the recognizing the multiple real planes in the real environment by computing the video image includes: recognizing all planes in the video image at one time; or successively recognizing planes in the video image; or recognizing required planes based on an animation requirement of the virtual object.

Further, the recognizing the multiple real planes in the real environment by computing the video image includes: detecting a plane pose and a camera pose in a world coordinate system by using an SLAM algorithm.

The generating, based on the recognized real planes, the animation track of the virtual object drawn for the virtual object further includes:

computing a pose of the virtual object relative to a world coordinate system based on a plane pose in the world coordinate system and a pose of the virtual object relative to a plane coordinate system of a recognized plane;

computing, based on a camera pose in the world coordinate system, a view matrix H for transforming the pose of the virtual object relative to the world coordinate system into a pose of the virtual object relative to a camera coordinate system;

generating animation track data of the virtual object based on data of a majority of the multiple recognized real planes; and

drawing, based on the animation track data, a three-dimensional graph corresponding to the animation track data, and generating multiple virtual graph frames, to form the animation track of the virtual object.

Further, the animation track data includes a coordinate position in the camera coordinate system, an animation curve, and a jump relationship.

The method further includes: generating an animation key point of the virtual object based on poses of the recognized real planes and the jump relationship; and generating, with the animation key point as a parameter, the animation track of the virtual object by using a Bezier curve configuration.

In order to achieve the above objects, the following technical solutions are provided according to another aspect of the present disclosure.

A multi-plane model animation interaction apparatus for augmented reality is provided. The device includes an acquiring module, a recognizing module, an arranging module, and a generating module.

The acquiring module is configured to acquire a video image of a real environment. The recognizing module is configured to recognize real planes in the real environment by computing the video image. The arranging module is configured to arrange a virtual object corresponding to the model on one of the real planes. The generating module is configured to generate, based on the recognized real planes, an animation track of the virtual object among the real planes.

Further, the recognizing module is configured to recognize real planes in the real environment by performing a step of: recognizing all planes in the video image at one time; or successively recognizing planes in the video image; or recognizing required planes based on an animation requirement of the virtual object.

Further, the recognizing module is configured to recognize real planes in the real environment by performing a step of: detecting a plane pose and a camera pose in a world coordinate system by using an SLAM algorithm.

Further, the generating module is configured to generate, based on the recognized real planes, the animation track of the virtual object by performing steps of:

computing a pose of the virtual object relative to a world coordinate system based on a plane pose in the world coordinate system and a pose of the virtual object relative to a plane coordinate system of a recognized plane;

computing, based on a camera pose in the world coordinate system, a view matrix H for transforming the pose of the virtual object relative to the world coordinate system into a pose of the virtual object relative to a camera coordinate system;

generating animation track data of the virtual object based on data of the multiple recognized real planes; and

drawing, based on the animation track data, a three-dimensional graph corresponding to the animation track data, and generating multiple virtual graph frames, to form the animation track of the virtual object.

Further, the animation track data includes a coordinate position in the camera coordinate system, an animation curve, and a jump relationship.

The generating module is further configured to: generate an animation key point of the virtual object based on poses of the recognized real planes and the jump relationship; and generate, with the animation key point as a parameter, the animation track of the virtual object by using a Bezier curve configuration.

In order to achieve the above objects, the following technical solutions are provided according to another aspect of the present disclosure.

A multi-plane model animation interaction device for augmented reality is provided. The device includes a processor and a memory. The memory is configured to store computer readable instructions. The processor is configured to execute the computer readable instructions, to perform the above multi-plane model animation interaction method for augmented reality.

In order to achieve the above objects, the following technical solutions are provided according to another aspect of the present disclosure.

A computer readable storage medium is provided. The computer readable storage medium is configured to store computer readable instructions. The computer readable instructions, when being executed by a computer, cause the computer to perform the above multi-plane model animation interaction method for augmented reality.

A multi-plane model animation interaction method, a multi-plane model animation interaction apparatus, and a multi-plane model animation interaction device for augmented reality, and a computer readable storage medium are provided according to embodiments of the present disclosure. The multi-plane model animation interaction method for augmented reality includes: acquiring a video image of a real environment; recognizing multiple real planes in the real environment by computing the video image; arranging a virtual object corresponding to the model on one of the multiple real planes; and generating, based on the multiple recognized real planes, an animation track of the virtual object among the multiple real planes. In this method, the animation track of the virtual object is generated based on the recognized real planes in the real environment, such that animation effects of the virtual object can be associated with the real environment, thereby enhancing real sensory experience of users.

The above description is only a summary of the technical solutions of the present disclosure. In order to more clearly understand the technical means of the present disclosure so as to implement the present disclosure in accordance with contents of this specification, preferred embodiments are described in detail below with reference to the accompanying drawings, such that the above-described and other objects, features and advantages of the present disclosure can be more apparent and more clearly understood.

### BRIEF DESCRIPTION OF THE DRAWINGS

FIG. 1 is a flowchart of a multi-plane model animation interaction method for augmented reality according to an embodiment of the present disclosure;

FIG. 2 is a flowchart of a multi-plane model animation interaction method for augmented reality according to another embodiment of the present disclosure;

FIG. 2a shows an example for generating a virtual object animation according to an embodiment of the present disclosure;

FIG. 3 is a schematic structural diagram of a multi-plane model animation interaction apparatus for augmented reality according to an embodiment of the present disclosure;

FIG. 4 is a schematic structural diagram of a multi-plane model animation interaction device for augmented reality according to an embodiment of the present disclosure;

FIG. 5 is a schematic structural diagram of a computer readable storage medium according to an embodiment of the present disclosure; and

FIG. 6 is a schematic structural diagram of a multi-plane model animation interaction terminal for augmented reality according to an embodiment of the present disclosure.

### DETAILED DESCRIPTION OF EMBODIMENTS

Embodiments of the present disclosure are described below by specific examples. Those skilled in the art can easily understand other advantages and effects of the present disclosure from contents disclosed in this specification. It is apparent that the described embodiments are only a part of embodiments rather than all embodiments of the present disclosure. The present disclosure may be implemented or applied in various other specific embodiments. Based on various views and applications, various modifications and changes may be made to details in this specification without departing from the spirit of the disclosure. It should be noted that the following embodiments and features in the embodiments may be combined with each other without conflict. Based on the embodiments of the present disclosure, all other embodiments obtained by those skilled in the art without any creative work should fall within the scope of the disclosure.

It should be noted that various aspects of the embodiments within the scope of the appended claims are described below. It is apparent that the aspects described herein may be embodied in a wide variety of forms, and any particular structure and/or function described herein is merely illustrative. Based on the present disclosure, those skilled in the art should understand that one aspect described herein may be implemented independently of any other aspect and two or more of these aspects may be combined in various ways. For example, the device and/or the method may be implemented and/or practiced by any number of the aspects described herein. In addition, the device and/or the method may be implemented and/or practiced by other structures and/or functionalities than one or more of the aspects described herein.

It should be further noted that the drawings provided in the following embodiments merely schematically illustrate basic concepts of the present disclosure. The drawings shows only the components related to the present disclosure. The components are not drawn based on numbers, shapes, and sizes of the components in actual implementations. In the actual implementations, modes, numbers, and scales of the components may be optionally changed, and a layout of the components may be more complicated.

In addition, in the following description, specific details are provided for a thorough understanding of the examples. However, those skilled in the art should understand that the aspects can be practiced without the specific details.

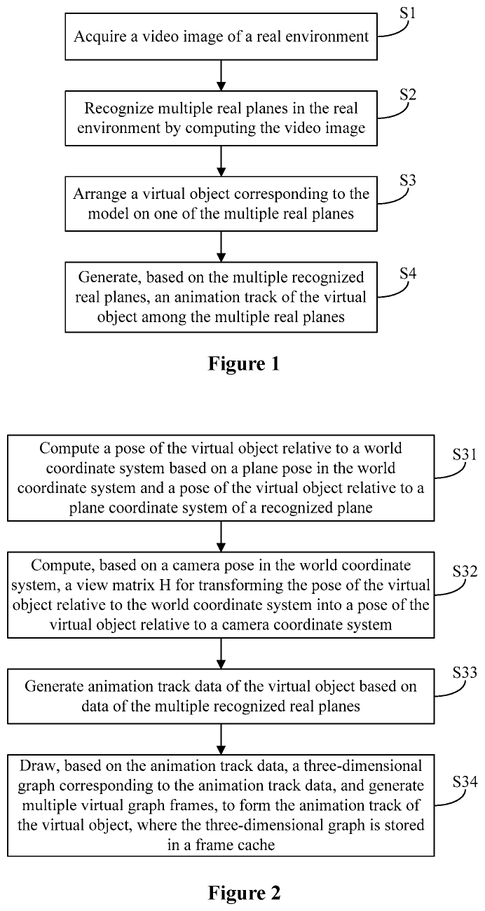

In order to solve the technical problem of how to enhance real sensory experience effects of users, a multi-plane model animation interaction method for augmented reality is provided according to an embodiment of the present disclosure. As shown in FIG. 1, the multi-plane model animation interaction method for augmented reality includes the following steps S1 to S4.

In step S1, a video image of a real environment is acquired.

First, a graphical system environment is initialized, to set a drawing environment supporting two-dimensional graphs and three-dimensional graphs, which includes setting a display mode, setting a display parameter list, setting a display device, creating a display surface, setting display surface parameters, setting a viewpoint position and a view plane, and the like.

A graphics system generally uses an image acquisition device such as an image camera or a video camera to capture the video image of the real environment. Internal parameters of the image camera and the video camera refer to internal intrinsic parameters such as a focal length and distortion of the camera. A projection conversion matrix of the camera is determined based on the internal parameters, which depend on attributes of the camera. Therefore, the internal parameters are constant for one camera. The internal parameters of the camera are acquired in advance through an independent camera calibration program. Here, the parameters are read and are stored into a memory.

The video image is captured by the image camera or the video camera. Then, the video image is processed. For example, the video image is scaled, or is binarized, gradation of the video image is processed, or a contour of the video image is extracted.

In step S2, multiple real planes in the real environment are recognized by computing the video image.

The real planes may be recognized by: recognizing all planes in the video image at one time, successively recognizing planes in the video image, or recognizing required planes based on an animation requirement of the virtual object.

The real planes may be recognized in various manners. A plane pose and a camera pose in a world coordinate system is detected by using a simultaneous localization and mapping (SLAM) algorithm. Pose information includes a position (a three-dimensional coordinate) and an attitude (including rotation angles relative to an X axes, a Y axes, and a Z axes, respectively), and is usually expressed by a pose matrix. The world coordinate system is an absolute coordinate system of the system. Before a user coordinate system (that is, a camera coordinate system) is established, coordinates of all points on an image are determined relative to an origin of the world coordinate system.

In an embodiment, the real plane is detected and recognized by aligning feature points. Discrete feature points such as SIFT, SURF, FAST, or ORB feature points in the video frame image are extracted, and feature points on adjacent images are matched. A pose increment of the camera is calculated based on matched feature points, and three-dimensional coordinates of the feature points are obtained by using a triangulation technique. If a majority of the extracted feature points are located in one plane, planes in the real environment are estimated based on extracted FAST corner points by using a RANSAC algorithm.

In an embodiment, a real plane is detected and recognized by using a method based on image alignment. All pixel pointes on a previous frame and a current frame of the video frame image are directly aligned, the pose increment of the camera between adjacent frames is calculated based on information of all pixel pointes in the image, and depth information of the pixel pointes in the image is recovered, so as to obtain a real plane.

In an embodiment, the video frame image is transformed into a three-dimensional point cloud, and a single-frame three-dimensional point cloud is reconstructed; features of two adjacent frames are extracted by using a SURF feature descriptor, a Euclidean distance is used as a similarity measurement, and a preliminary rotation matrix of two adjacent single-frame three-dimensional point clouds is obtained based on a PnP solution; each reconstructed single-frame point cloud is down-sampled by a VoxelGrid filter, and a plane pose is extracted from each single-frame three-dimensional point cloud by using an RANSAC algorithm; and a position of each real plane is determined based on the plane pose extracted from each single-frame three-dimensional point cloud.

In step S3, a virtual object corresponding to the model is arranged on one of the multiple real planes.

The model may be a 3D model. When being arranged in the video image, one 3D model corresponds to one virtual object. The virtual object is arranged on the real plane recognized in step S2. A plane on which the virtual object is arranged is not limited herein. The virtual object may be arranged on a first recognized plane, or may be arranged on a plane specified by the user. In step S4, an animation track of the virtual object among the multiple real planes is generated based on the multiple recognized real planes.

A pose of the virtual object relative to a three-dimensional plane coordinate system of the recognized plane is usually preset in the system (for example, the virtual object is directly arranged at an origin of the plane) or is specified by the user.

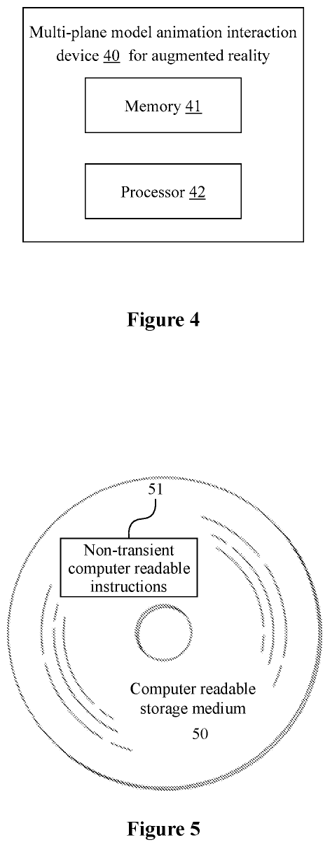

As shown in FIG. 4, step 4 includes the following steps S31 to S34.

In step S31, a pose of the virtual object relative to the world coordinate system is computed based on the plane pose in the world coordinate system and a pose of the virtual object relative to a plane coordinate system of a recognized plane.

In step S32, a view matrix H is computed based on a camera pose in the world coordinate system. The view matrix H is used for transforming the pose of the virtual object relative to the world coordinate system into a pose of the virtual object relative to a camera coordinate system.

In a process that the recognized plane is imaged on a display image, points on the recognized plane are transformed from the world coordinate system to the camera coordinate system, and then projected to the display image to form a two-dimensional image of the plane. Based on the recognized plane, a three-dimensional virtual object corresponding to the plane is retrieved from data that is preset in the system or specified by the user. A vertices array of the three-dimensional virtual object is acquired. Finally, vertex coordinates in the vertices array are multiplied by the view matrix H, to obtain coordinates of the three-dimensional virtual object in the camera coordinate system.

After the camera coordinate system and a corresponding camera coordinate in the world coordinate system are obtained, a product of a projection matrix and the view matrix H is calculated based on a simultaneous equation set. The projection matrix completely depends on the internal parameters of the camera, so that the view matrix H is calculated.

After all internal parameters and external parameters of the camera are calculated, 3D-2D transformation from the camera coordinate system to the display image is performed based on computing.

In step S33, animation track data of the virtual object is generated based on data of the recognized real planes (including the plane pose). The animation track data includes a coordinate position in the camera coordinate system, an animation curve, and a jump relationship. An animation key point of the virtual object is generated based on positions of the recognized real planes and the jump relationship of the virtual object. Alternatively, the jump relationship and the animation curve may be generated by setting the animation key point.

The jump relationship of the animation track indicates, for example, a plane to which the virtual object first jumps, and another plane to which the virtual object subsequently jumps.

In step S34, a three-dimensional graph corresponding to the animation track data is drawn based on the animation track data and is stored in a frame cache. Multiple virtual graph frames are generated to form the animation track of the virtual object.

In an embodiment, the animation curve, that is, the animation track of the virtual object is generated by using a Bezier curve configuration, so as to achieve accurate drawing and configuration. An order of a Bezier curve equation, such as a first order, a second order, a third order or a higher order, is determined based on the animation track data. The Bezier curve equation, such as a linear Bezier curve equation, a quadratic Bezier curve equation, a cubic Bezier curve equation or a higher order Bezier curve equation, is created with the animation key point of the virtual object as a control point of the Bezier curve. A Bezier curve is drawn according to the Bezier curve equation, so as to form the animation curve, that is, the animation track of the virtual object.

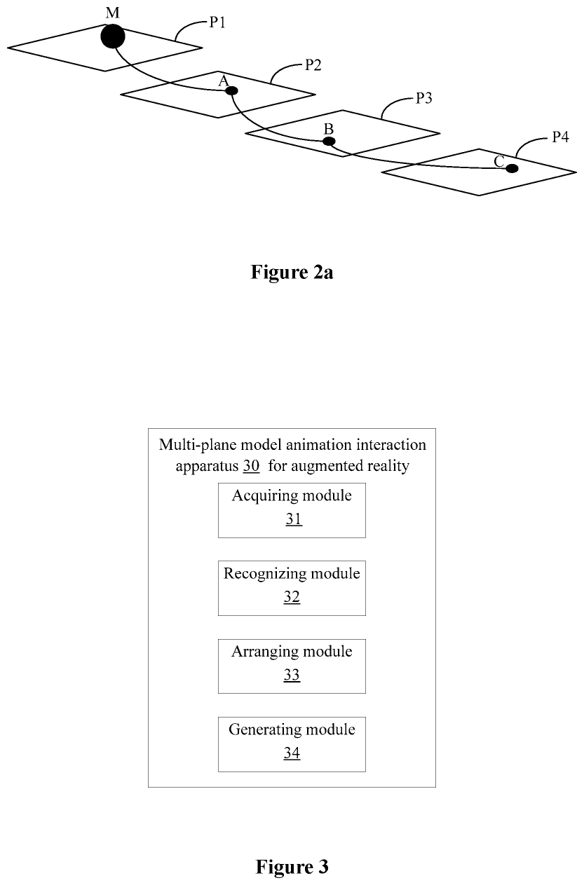

For ease of understanding, reference is made to FIG. 2a, which shows an example of a multi-plane model animation interaction method for augmented reality according to an embodiment of the present disclosure. As shown in FIG. 2, four real planes, namely, planes P1, P2, P3, and P4 are recognized in step S2. A virtual object M is arranged on the plane P1. In this example, the user may set a key point of the animation. As shown in FIG. 2a, key points A, B, and C are located on the planes P2, P3, and P4, respectively. A jump relationship is from P1 to P2 to P3, and then to P4. In this way, the animation is generated based on the key points and the jump relationship. For example, the key points are taken as control points of the Bezier curve, to create the Bezier curve equation, so as to generate the animation curve of the virtual object.

In order to solve the technical problem of how to enhance real sensory experience effects of users, a multi-plane model animation interaction apparatus 30 for augmented reality is provided according to an embodiment of the present disclosure. The apparatus is capable of performing the steps described in the embodiments of the above multi-plane model animation interaction method for augmented reality. As shown in FIG. 3, the apparatus 30 includes an acquiring module 31, a recognizing module 32, an arranging module 33, and a generating module 34.

The acquiring module 31 is configured to acquire a video image of a real environment.

The acquiring module is generally implemented by a graphical system.

First, a graphical system environment is initialized, to set a drawing environment supporting two-dimensional graphs and three-dimensional graphs, which includes setting a display mode, setting a display parameter list, setting a display device, creating a display surface, setting display surface parameters, setting a viewpoint position and a view plane, and the like.

The graphics system generally uses an image acquisition device such as an image camera or a video camera to capture the video image of the real environment. Internal parameters of the image camera and the video camera refer to internal intrinsic parameters such as a focal length and distortion of the camera. A projection conversion matrix of the camera is determined based the internal parameters, which depend on attributes of the camera. Therefore, the internal parameters are constant for one camera. The internal parameters of the camera are acquired in advance through an independent camera calibration program. Here, the parameters are read and are stored into a memory.

The acquiring module captures the video image via the image camera or the video camera, and processes the video image, for example, scales or binarizes the video image, processes gradation of the video image, or extracts a contour of the video image.

The recognizing module 32 is configured to recognize real planes in the real environment by computing the video image acquired by the acquiring module.

The real planes may be recognized by: recognizing all planes in the video image at one time, successively recognizing planes in the video image, or recognizing required planes based on an animation requirement of the virtual object.

The real planes may be recognized in various manners. A plane pose and a camera pose in a world coordinate system is detected by using a simultaneous localization and mapping (SLAM) algorithm. Pose information includes a position (a three-dimensional coordinate) and an attitude (including rotation angles relative to an X axes, a Y axes, and a Z axes, respectively), and is usually expressed by a pose matrix.

In an embodiment, the real plane is detected and recognized by aligning feature points. Discrete feature points such as SIFT, SURF, FAST, or ORB feature points in the video frame image are extracted, and feature points on adjacent images are matched. A pose increment of the camera is calculated based on matched feature points, and three-dimensional coordinates of the feature points are obtained by using a triangulation technique. If a majority of the extracted feature points are located in one plane, planes in the real environment are estimated based on extracted FAST corner points by using a RANSAC algorithm.

In an embodiment, a real plane is detected and recognized by using a method based on image alignment. All pixel pointes on a previous frame and a current frame of the video frame image are directly aligned, the pose increment of the camera between adjacent frames is calculated based on information of all pixel pointes in the image, and depth information of the pixel pointes in the image is recovered, so as to obtain a real plane.

In an embodiment, the video frame image is transformed into a three-dimensional point cloud, and a single-frame three-dimensional point cloud is reconstructed; features of two adjacent frames are extracted by using a SURF feature descriptor, a Euclidean distance is used as a similarity measurement, and a preliminary rotation matrix of two adjacent single-frame three-dimensional point clouds is obtained based on a PnP solution; each reconstructed single-frame point cloud is down-sampled by a VoxelGrid filter, and a plane pose is extracted from each single-frame three-dimensional point cloud by using an RANSAC algorithm; and a position of each real plane is determined based on the plane pose extracted from each single-frame three-dimensional point cloud.

The arranging module 33 is configured to arrange a virtual object corresponding to the model on one of the real planes.

The model may be a 3D model. When being arranged in the video image, one 3D model corresponds to one virtual object. The virtual object is arranged on the real plane recognized in step S2. A plane on which the virtual object is arranged is not limited herein. The virtual object may be arranged on a first recognized plane, or may be arranged on a plane specified by a user.

The generating module 34 is configured to generate, based on the recognized real planes, an animation track of the virtual object among the real planes.

A pose of the virtual object (the 3D model) relative to a three-dimensional plane coordinate system of the recognized plane is usually preset in the system (for example, the virtual object is directly arranged at an origin of the plane) or is specified by the user.

The generating module 34 performs the following steps S31 to S34.

In step S31, a pose of the virtual object relative to the world coordinate system is computed based on the plane pose in the world coordinate system and a pose of the virtual object relative to a plane coordinate system of a recognized plane.

In step S32, a view matrix H is computed, based on a camera pose in the world coordinate system. The view matrix H is used for transforming the pose of the virtual object relative to the world coordinate system into a pose of the virtual object relative to a camera coordinate system.

In a process that the recognized plane is imaged on a display image, points on the recognized plane are transformed from the world coordinate system to the camera coordinate system, and then projected to the display image to form a two-dimensional image of the plane. Based on the recognized plane, a three-dimensional virtual object corresponding to the recognized plane is retrieved from data that is preset in the system or specified by the user. A vertices array of the three-dimensional virtual object is acquired. Finally, vertex coordinates in the vertices array are multiplied by the view matrix H, to obtain coordinates of the three-dimensional virtual object in the camera coordinate system.

After the camera coordinate system and a corresponding camera coordinate in the world coordinate system are obtained, a product of a projection matrix and the view matrix H is calculated based on a simultaneous equation set. The projection matrix completely depends on the internal parameters of the camera, so that the view matrix H is calculated.

After all internal parameters and external parameters of the camera are calculated, 3D-2D transformation from the camera coordinate system to the display image is performed based on computing.

In step S33, animation track data of the virtual object is generated based on data of the recognized real planes (including the plane pose). The animation track data includes a coordinate position in the camera coordinate system, an animation curve, and a jump relationship. An animation key point of the virtual object is generated based on positions of the recognized real planes and the jump relationship of the virtual object defined for the virtual object.

The jump relationship of the animation track indicates, for example, a plane to which the virtual object first jumps, and another plane to which the virtual object subsequently jumps.

In step S34, a three-dimensional graph corresponding to the animation track data is generated based on the animation track data and is stored in a frame cache. Multiple virtual graph frames are generated to form the animation track of the virtual object.

In an embodiment, the animation curve, that is, the animation track of the virtual object is generated by using a Bezier curve configuration, so as to achieve accurate drawing and configuration. An order of a Bezier curve equation, such as a first order, a second order, a third order or a higher order, is determined based on the animation track data. The Bezier curve equation, such as a linear Bezier curve equation, a quadratic Bezier curve equation, a cubic Bezier curve equation or a higher order Bezier curve equation, is created with the animation key point of the virtual object as a control point of the Bezier curve. A Bezier curve is drawn according to the Bezier curve equation, so as to form the animation curve, that is, the animation track of the virtual object.

FIG. 4 is a block diagram showing hardware of a multi-plane model animation interaction device for augmented reality according to an embodiment of the present disclosure. As shown in FIG. 4, the multi-plane model animation interaction device 40 for augmented reality according to the embodiment of the present disclosure includes a memory 41 and a processor 42.

The memory 41 is configured to store non-transient computer readable instructions. The memory 41 may include one or more computer program products, which may include various forms of computer readable storage media such as a volatile memory and/or a nonvolatile memory. The volatile memory may include, for example, a random access memory (RAM) and/or a cache memory or the like. The nonvolatile memory may include, for example, a read only memory (ROM), a hard disk, a flash memory or the like.

The processor 42 may be a central processing unit (CPU) or other processing units having data processing capabilities and/or instruction execution capabilities, and can control other components in the multi-plane model animation interaction device 40 for augmented reality to perform desired functions. In an embodiment of the present disclosure, the processor 42 is configured to execute the computer readable instructions stored in the memory 41, so that the multi-plane model animation interaction device 40 for augmented reality performs all or part of the steps of the above multi-plane model animation interaction method for augmented reality according to the embodiments of the present disclosure.

Those skilled in the art should understand that, in order to solve the technical problem of how to acquire good user experience effects, well-known structures such as a communication bus, an interface and the like may be also included in this embodiment. These well-known structures are also included in the protection scope of the present disclosure.

For a detailed description of this embodiment, reference may be made to the corresponding description in the above embodiments, and is not repeated herein.

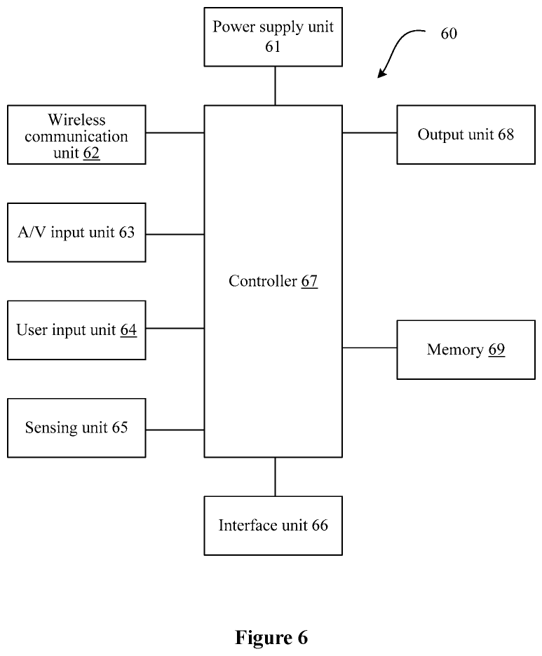

FIG. 5 is a schematic diagram of a computer readable storage medium according to an embodiment of the present disclosure. As shown in FIG. 5, the computer readable storage medium 50 according to the embodiment of the present disclosure stores non-transient computer readable instructions 51. The non-transient computer readable instructions 51, when being executed by a processor, perform all or part of the steps of the above multi-plane model animation interaction method for augmented reality according to the embodiments of the present disclosure.

The above computer readable storage medium may include but is not limited to: an optical storage medium (for example, a CD-ROM and a DVD), a magneto-optical storage medium (for example, a MO), a magnetic storage medium (for example, a tape or a mobile hard disk), a medium with a built-in rewritable non-volatile memory (for example, a memory card) and a medium with a built-in ROM (for example, a ROM box).

For a detailed description of this embodiment, reference may be made to the corresponding description in the above embodiments, and is not repeated herein.

For a detailed description of this embodiment, reference may be made to the corresponding description in the above embodiments, and is not repeated herein.

FIG. 6 is a schematic structural diagram showing hardware of a terminal according to an embodiment of the present disclosure. As shown in FIG. 6, a multi-plane model animation interaction terminal 60 for augmented reality includes the embodiments of the multi-plane model animation interaction device for augmented reality.

The terminal may be implemented in various forms. The terminal in the present disclosure may include but is not limited to a mobile terminal such as a mobile phone, a smart phone, a notebook computer, a digital broadcast receiver, a PDA (personal digital assistant), a PAD (tablet computer), a PMP (portable multimedia player), a navigation device, an in-vehicle terminal, an in-vehicle display terminal, an in-vehicle electronic rearview mirror and the like, and a fixed terminal such as a digital TV, a desktop computer and the like.

In an equivalent alternative embodiment, the terminal may further include other components. As shown in FIG. 6, the multi-plane model animation interaction terminal 60 for augmented reality may include a power supply unit 61, a wireless communication unit 62, an A/V (audio/video) input unit 63, a user input unit 64, a sensing unit 65, an interface unit 66, a controller 67, an output unit 68 and a memory 69. FIG. 6 shows a terminal including various components, but it should be understood that not all illustrated components are required to be implemented. Alternatively, more or fewer components may be implemented.

The wireless communication unit 62 allows the terminal 60 to be wirelessly communicated with a wireless communication system or network. The A/V input unit 63 is configured to receive an audio signal or a video signal. The user input unit 64 is configured to generate key input data based on a command inputted by the user, to control various operations of the terminal. The sensing unit 65 is configured to detect a current state of the terminal 60, a position of the terminal 60, a presence or an absence of a touch input from the user to the terminal 60, an orientation of the terminal 60, an acceleration movement or a deceleration movement and a direction of the terminal 60, and the like, and generate a command or a signal for controlling operations of the terminal 60. The interface unit 66 functions as an interface via which at least one external device is connected to the terminal 60. The output unit 68 is configured to provide an output signal in a visual, audio, and/or tactile manner. The memory 69 is configured to store a software program for processing and control operations performed by the controller 66, or may be configured to temporarily store data that is outputted or is to be outputted. The memory 69 may include at least one type of storage medium. Moreover, the terminal 60 may cooperate with a network storage device that performs a storage function of the memory 69 via a network connection. The controller 67 usually controls overall operations of the terminal. In addition, the controller 67 may include a multimedia module for reproducing or playing back multimedia data. The controller 67 may perform pattern recognition processing, to recognize a handwriting input or a picture drawing input performed on a touch screen as a character or an image. The power supply unit 61 is configured to receive external power or internal power under control of the controller 67, and provide appropriate power required to operate the units and the components.

Various embodiments of the multi-plane model animation interaction method for augmented reality provided in the present disclosure may be implemented by, for example, computer software, hardware, or a computer readable medium of any combination of the computer software and the hardware. For hardware implementations, the various embodiments of the multi-plane model animation interaction method for augmented reality in the present disclosure may be implemented by at least one of an application specific integrated circuit (ASIC), a digital signal processor (DSP), a digital signal processing device (DSPD), and a programmable logic device (PLD), a field programmable gate array (FPGA), a processor, a controller, a microcontroller, a microprocessor, an electronic unit designed to perform the functions described herein. In some cases, the various embodiments of the multi-plane model animation interaction method for augmented reality in the present disclosure may be implemented in the controller 67. For software implementations, the various embodiments of the multi-plane model animation interaction method for augmented reality in the present disclosure may be implemented by a separate software module that allows execution of at least one function or operation. A software code may be implemented by a software application program (or a program) written in any appropriate programming language. The software code may be stored in the memory 69 and executed by the controller 67.

For a detailed description of this embodiment, reference may be made to the corresponding description in the above embodiments, and is not repeated herein.

Basic principles of the present disclosure are described above in connection with specific embodiments. However, it should be noted that, merits, advantages, effects and the like illustrated herein are merely examples and are not restrictions, and are not considered to be necessary for the embodiments of the present disclosure. In addition, the above disclosed details are only for the purpose of illustration and ease of understanding, and are not limitation. The above details are not intended to limit that the present disclosure must be implemented by using the above details.

In addition, the block diagrams of the component, the device, the apparatus, and the system involved in the present disclosure are merely illustrative, and are not intended to be required or implied that the component, the device, the apparatus, and the system must be connected, arranged, and configured as shown in the block diagrams. As those skilled in the art are to be appreciated that, the component, the device, the apparatus, and the system may be connected, arranged, and configured in any manner. Expressions such as “including”, “comprising”, “having” and the like are open expressions indicating “including but not limited to” and may be exchanged with “including but not limited to”. Expressions of “or” and “and” used herein refer to an expression “and/or” and may be exchanged with “and/or”, unless the context clearly indicates that the expressions “or” and “and” used herein do not refer to the expression “and/or”. An expression of “such as” used herein refers to a phrase “such as but not limited to” and may be exchanged with the phrase “such as but not limited to”.

In addition, as used herein, the expression “or” in an enumeration of items started with “at least one” indicates a separate enumeration, so that an enumeration, for example, “at least one of A, B, or C”, indicates A, or B, or C, or AB, or AC, or BC, or ABC (that is, A and B and C). Further, an expression “exemplary” does not indicate that the described example is preferred or better than other examples.

It should be further noted that, in the system and the method in the present disclosure, the components or the steps may be decomposed or recombined. The decomposing and/or recombining should be regarded as equivalent solutions of the present disclosure.

Various changes, substitutions and alterations of the technologies described herein may be made without departing from the technologies defined in the appended claims. Further, the scope of the claims of the present disclosure is not limited to the specific aspects of the above described processing, machine, manufacture, composition of events, mean, method and action. A currently existing or later to be developed processing, machine, manufacture, composition of events, mean, method or action that performs approximately identical functions or achieves approximately identical results to the corresponding aspects described herein may be used. Therefore, the appended claims include the processing, the machine, the manufacture, the composition of events, the mean, the method or the action that are in the scope of the appended claims.

The above description of the disclosed aspects is provided, so that those skilled in the art can make or use the present disclosure. Various modifications to the aspects are obvious to those skilled in the art, and general principles defined herein may be applicable in other embodiments without departing from the scope of the present disclosure. Therefore, the present disclosure is not intended to be limited to the aspects described herein but accords with the widest scope that complies with the principles and novelty disclosed herein.

The above description is provided for purposes of illustration and description. Further, the description is not intended to limit the embodiments of the present disclosure to the forms disclosed herein. Although multiple example aspects and embodiments are discussed in the above, those skilled in the art will understand some variations, modifications, changes, additions and sub-combinations thereof

What is claimed is:

1. A multi-plane model animation interaction method for augmented reality, comprising:
acquiring a video image of a real environment;
recognizing a plurality of real planes in the real environment by computing the video image;
arranging a virtual object corresponding to the model on one of the plurality of real planes; and
generating, based on the plurality of recognized real planes, an animation track of the virtual object among the plurality of real planes.

2. The multi-plane model animation interaction method for augmented reality according to claim 1, wherein the recognizing the plurality of real planes in the real environment by computing the video image comprises:
recognizing all planes in the video image at one time; or
successively recognizing planes in the video image; or
recognizing required planes based on an animation requirement of the virtual object.

3. The multi-plane model animation interaction method for augmented reality according to claim 1, wherein the recognizing the plurality of real planes in the real environment by computing the video image comprises:
detecting a plane pose and a camera pose in a world coordinate system by using an SLAM algorithm.

4. The multi-plane model animation interaction method for augmented reality according to claim 1, wherein the generating, based on the plurality of recognized real planes, the animation track of the virtual object among the plurality of real planes comprises:
computing a pose of the virtual object relative to a world coordinate system based on a plane pose in the world coordinate system and a pose of the virtual object relative to a plane coordinate system of a recognized plane;
computing, based on a camera pose in the world coordinate system, a view matrix H for transforming the pose of the virtual object relative to the world coordinate system into a pose of the virtual object relative to a camera coordinate system;
generating animation track data of the virtual object based on data of the plurality of recognized real planes; and
drawing, based on the animation track data, a three-dimensional graph corresponding to the animation track data, and generating a plurality of virtual graph frames, to form the animation track of the virtual object.

5. The multi-plane model animation interaction method for augmented reality according to claim 4, wherein the animation track data comprises a coordinate position in the camera coordinate system, an animation curve, and a jump relationship.

6. The multi-plane model animation interaction method for augmented reality according to claim 5, further comprising:
generating an animation key point of the virtual object based on poses of the recognized real planes and the jump relationship; and
generating, with the animation key point as a parameter, the animation track of the virtual object by using a Bezier curve configuration.

7. (canceled)

8. A multi-plane model animation interaction device for augmented reality, comprising:
a memory configured to store computer readable instructions; and
a processor configured to execute the computer readable instructions, to perform operations, the operations comprising:
acquiring a video image of a real environment;
recognizing a plurality of real planes in the real environment by computing the video image;
arranging a virtual object corresponding to the model on one of the plurality of real planes; and
generating, based on the plurality of recognized real planes, an animation track of the virtual object among the plurality of real planes.

9. A computer readable storage medium stored thereon computer readable instructions that, when being executed by a computer, cause the computer to perform operations, the operations comprising:
acquiring a video image of a real environment;
recognizing a plurality of real planes in the real environment by computing the video image;
arranging a virtual object corresponding to the model on one of the plurality of real planes; and
generating, based on the plurality of recognized real planes, an animation track of the virtual object among the plurality of real planes.

10. The multi-plane model animation interaction device for augmented reality according to claim 8, wherein the recognizing the plurality of real planes in the real environment by computing the video image comprises:
recognizing all planes in the video image at one time; or
successively recognizing planes in the video image; or
recognizing required planes based on an animation requirement of the virtual object.

11. The multi-plane model animation interaction device for augmented reality according to claim 8, wherein the recognizing the plurality of real planes in the real environment by computing the video image comprises:
detecting a plane pose and a camera pose in a world coordinate system by using an SLAM algorithm.

12. The multi-plane model animation interaction device for augmented reality according to claim 8, wherein the generating, based on the plurality of recognized real planes, the animation track of the virtual object among the plurality of real planes comprises:
computing a pose of the virtual object relative to a world coordinate system based on a plane pose in the world coordinate system and a pose of the virtual object relative to a plane coordinate system of a recognized plane;
computing, based on a camera pose in the world coordinate system, a view matrix H for transforming the pose of the virtual object relative to the world coordinate system into a pose of the virtual object relative to a camera coordinate system;
generating animation track data of the virtual object based on data of the plurality of recognized real planes; and
drawing, based on the animation track data, a three-dimensional graph corresponding to the animation track data, and generating a plurality of virtual graph frames, to form the animation track of the virtual object.

13. The multi-plane model animation interaction device for augmented reality according to claim 12, wherein the animation track data comprises a coordinate position in the camera coordinate system, an animation curve, and a jump relationship.

14. The multi-plane model animation interaction device for augmented reality according to claim 13, wherein the operations further comprise:
generating an animation key point of the virtual object based on poses of the recognized real planes and the jump relationship; and
generating, with the animation key point as a parameter, the animation track of the virtual object by using a Bezier curve configuration.
